(19) United States
(12) Patent Application Publication
(10) Pub. No.: US 2002/0017531 A1
(43) Pub. Date: Feb. 14, 2002

(54) Device for expelling a product from a vending machine

(75) Inventor: Adriano Adriani, Schio (IT)

Correspondence Address: MODIANO & ASSOCIATI, Via Meravigli, 16, MILANO, 20123, IT

(73) Assignee: F.A.S. INTERNATIONAL S.p.A.

(21) Appl. No.: 09/915,317

(22) Filed: Jul. 27, 2001

(30) Foreign Application Priority Data
Aug. 10, 2000 (IT) VR2000U000037

(51) Int. Cl. G07F 11/42

(52) U.S. Cl. 221/15; 221/124

(57) ABSTRACT

A device for expelling a product from a vending machine, comprising a containment frame, a plurality of supporting shelves provided within the containment frame, at least one dispensing tray slidingly mounted on a respective supporting shelf so as to move between a position for loading products, in which it is at least partially extracted from the containment frame, and a position for unloading the products, at least one collection tray for the products unloaded from the respective dispensing tray which can be accessed from outside, and at least one helical dispenser element lying above a respective dispensing tray and is suitable to accommodate, a product to be dispensed. The device comprises at least one sensor which is suitable to check whether the product selected by the consumer has actually fallen from the respective dispensing tray and, if it has not, to drive the motor of the respective helical dispenser element.

### BACKGROUND OF THE INVENTION

The present invention relates to a device for expelling a product from a vending machine.

Vending machines which use a helical dispenser element to convey a product chosen by a consumer along a predefined path, until it falls into a collection tray which can be accessed from outside, are currently known.

A vending machine is generally constituted by a containment frame having a front access door, preferably transparent so as to allow the consumer to see the products available, multiple supporting shelves which are arranged at a predefined distance one above the other within the containment frame, and at least one dispensing tray slidingly mounted on the respective supporting shelf, so as to move between a position for loading the products to be dispensed, in which it is at least partially extracted from the containment frame, and a position for unloading the products, in which it is fully contained within the containment frame. A helical dispenser element is generally fitted above each dispensing tray and is suitable to accommodate, between each pair of consecutive turns, a product to be dispensed, so as to make it advance along the respective dispensing tray by rotating about its own longitudinal axis, until the product falls by gravity toward the lower portion of the containment frame. At such lower portion of the containment frame, and usually in a front position, also a collection tray is provide for the products unloaded from each dispensing tray, by virtue of which said products are rendered accessible to the consumer.

Previously, a vending machine as described above had drawbacks which often compromised its regular and continuous operation. A very frequent problem for this type of vending machine was in fact failure to dispense the product chosen by the consumer, because the product was often stuck between the helical dispenser element and the respective dispensing tray.

Over time, therefore, it has been noted that the defective operation of old-generation vending machines, besides to causing economic damage to the consumer, who was in any case forced to pay in advance and for whom there was no refund in case of failure to dispense the product, caused gradually increasing mistrust and therefore gradually decreasing use of this kind of vending machine by consumers.

In order to eliminate the causes of malfunction of these vending machines, some technical solutions aimed at ensuring correct expulsion of the products from the respective dispensing trays have been devised.

One of such technical solutions is disclosed in U.S. Pat. No. 4,061,245, which. uses, at the front end of each dispensing tray, a tab being slightly curved toward the tray, so as to engage, during use, the outermost turn of the respective helical dispenser element. By turning about its own longitudinal axis, the dispenser element is in fact designed to abut and gradually push against said tab, which by contrasting this force causes a partial compression of the front portion of said dispenser element.

When the point of contact between the tab and the first turn of the dispenser element reaches and moves beyond the front end of the helical dispenser element, the dispenser element disengages from the tab, restoring its natural length. The rapid expansion of the helical dispenser element to its natural length applies a thrust to the product to be expelled, which lies between its two first turns, so as to push it beyond the front end of the respective dispensing tray and make it fall into the underlying collection tray.

Another technical solution aimed at ensuring, in a vending machine, that a product chosen by a consumer is actually dispensed was devised by U.S. Pat. No. 3,737,071.

This patent in fact claims the use of a wing which is arranged proximate to the front end of each dispensing tray and is loaded by a helical spring, so that during use it lies above the product to be expelled, which is contained between the two first turns of the respective helical dispenser element.

After the consumer has selected a product among the available ones, an appropriately provided expulsion device lifts the product, which in turn lifts the wing and consequently loads the respective helical spring. When the product is raised above the front edge of the respective dispensing tray, the loaded wing applies thereto a thrust which is sufficient to make it fall by gravity into the collection tray.

Although both of the above described solutions are capable of ensuring that the product selected by the consumer is actually dispensed, it is evident that in both cases the product to be expelled receives an impulsive thrust of such a magnitude to free the preselected product from any obstacle that prevents it from falling from the respective dispensing tray.

The impulsive nature of the thrust applied to the selected product, however, can cause drawbacks, since the force applied to the individual product can be excessive if the product is particularly delicate and sensitive to impacts and is packaged in a nonrigid envelope. Both when the selected product is expelled by the rapid extension of the helical dispenser element and when it is expelled by the thrust of a wing pushed by the respective helical spring, there is the risk of compromising the integrity of such product and of objectively damaging the consumer.

### SUMMARY OF THE INVENTION

The aim of the present invention is to provide a device for expelling a product from a vending machine which is capable of eliminating or substantially reducing the above mentioned drawbacks related to current vending machines.

An object of the present invention is to provide a device as defined above which ensures correct operation of a vending machine, ensuring the correct expulsion of the products selected by a consumer without damaging in any way the container or the contents thereof.

Another object of the present invention is to provide a device which can be installed in vending machines currently being manufactured.

Another object of the present invention is to provide a device which is simple to manufacture and entails particularly low installation costs.

This aim and these and other objects which will become better apparent hereinafter are achieved by a device for expelling a product from a vending machine, said vending machine comprising a containment frame, a plurality of supporting shelves provided within said containment frame, at least one dispensing tray which is slidingly mounted on a respective supporting shelf so as to move between a position for loading products to be dispensed, in which it is at least partially extracted from said containment frame, and a position for unloading said products to be dispensed, in which it is fully contained within said containment frame, at least one collection tray for the products unloaded from the respective, or each, said dispensing tray which can be accessed from outside, and at least one helical dispenser element which lies above a respective dispensing tray and is suitable to accommodate, between at least two consecutive turns, a product to be dispensed, so as to make it advance along the respective dispensing tray by rotating about its own longitudinal axis, until it falls by gravity into said collection tray, said expulsion device being characterized in that it comprises sensor means downstream of the or each helical dispenser element and suitable to check whether the product selected by the consumer has actually fallen from the respective dispensing tray and, if it has not, to drive the motor of the respective helical dispenser element so as to subject said helical dispenser element to an additional partial rotation, so as to ensure the fall of said product into said collection tray.

Advantageously, said device comprises a monitoring and control unit which is suitable to receive from said sensor means an on/off signal related to the expulsion of said product from the respective dispensing tray and, if expulsion has not occurred, to drive the motor of the respective helical dispenser element so as to turn it through an additional quarter turn, said monitoring and control unit being suitable to memorize the occurrence of the rotation of the or each helical dispenser element through said additional quarter turn, so as to impart thereto, when a subsequent preselection of the corresponding product occurs, a rotation which is the full-turn complement of said additional quarter turn.

### BRIEF DESCRIPTION OF THE DRAWINGS

Further characteristics and advantages of the present invention will become better apparent from the description of a preferred but not exclusive embodiment thereof illustrated in the accompanying drawings, wherein:

FIG. 1 is a cutout sectional view, taken along a vertical transverse plane, of a vending machine according to the invention;

FIG. 2 is a schematic view of a monitoring and control system of the vending machine of FIG. 1;

FIG. 3 is an enlarged-scale perspective view of an expulsion device according to the invention during an initial step of the process for expelling a product;

FIG. 4 is an enlarged-scale perspective view of the expulsion device of FIG. 2 during an intermediate step of the process for expelling a product;

FIG. 5 is an enlarged-scale perspective view of the expulsion device of FIG. 2 during a final step of the process for expelling a product.

### DESCRIPTION OF THE PREFERRED EMBODIMENTS

In the accompanying drawings, identical or similar parts or components have been designated by the same reference numerals.

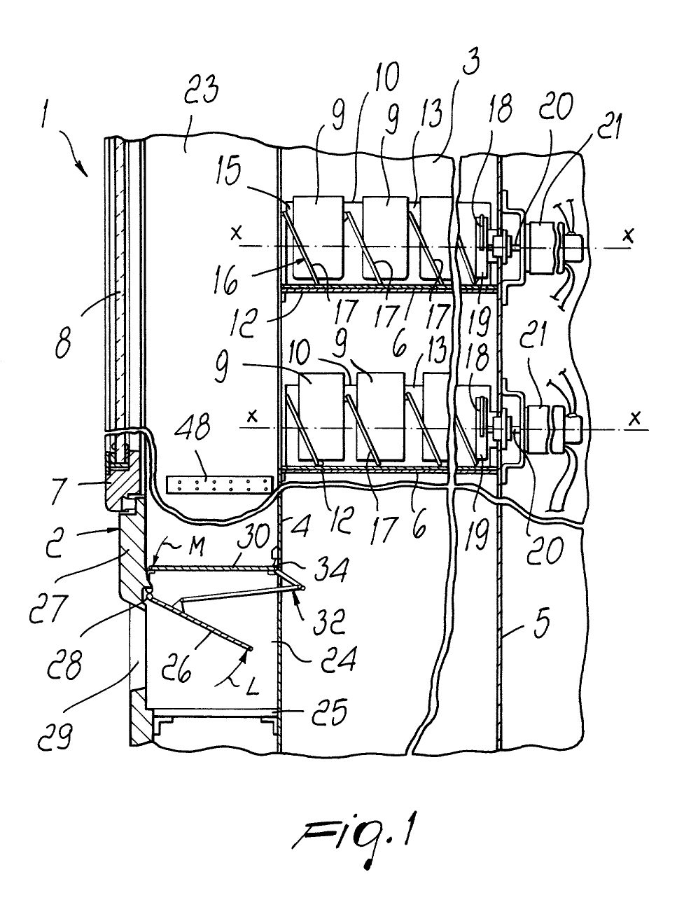

With reference first to FIG. 1, a vending machine according to the present invention, designated by the reference numeral 1, comprises a containment frame 2 which bounds an internal cavity 3 inside which a front partition 4 and a rear partition 5 are provided, both of which are vertical; said partitions are mutually spaced so as to support a plurality of substantially horizontal supporting shelves 6.

Preferably, the internal cavity 3 can be accessed from outside through a front door 7 which is hinged to the containment frame 2 and can have a transparent window 8 so as to allow the consumer to see the products 9 contained in the vending machine 1.

One or more dispensing trays 10 are fitted, preferably so that they can slide, on each supporting shelf 6; the trays can be provided with a plurality of rollers (not shown) which are designed to engage, by rolling, respective guides (also not shown) formed along the respective shelf 6, so as to be able to move, by roller-assisted sliding, between a position for loading products 9 to be dispensed, in which each dispensing tray 10 is at least partially extracted from the containment frame 2, and a position for dispensing the products 9, in which each dispensing tray 10 is fully contained within the containment frame 2.

Preferably, a dispensing tray 10 is composed of a bottom 12 and two side walls 13 and 14 (of which only the side wall 13 is visible in FIG. 1) which extend substantially at right angles to the front 4 and the rear 5 partitions and are suitable to define a respective compartment 15 for collecting and dispensing the products 9.

Inside each compartment 15 a dispenser element 16 is provided which advantageously is helical and has a substantially horizontal main axis x-x, around which multiple turns 17 having a constant pitch P lie. Each dispenser element 16 is supported at its rear end 18 by a flange 19 which is in turn axially keyed to a transmission shaft 20 which is adapted to transmit to the respective dispenser element 16 a rotary motion generated by a respective motor 21.

The front partition 4 further delimits, together with the front door 7 and in front of the dispenser elements 16, a compartment 23 which extends substantially vertically and is delimited in a downward region by a collection tray 24 to which the selected products 9 are meant to fall during use.

The collection tray 24 can be composed of a flat bottom 25, a front flap 26 which is mounted inside the front wall 27 of the vending machine 1, can oscillate freely about a horizontal pivot 28 and is designed to removably close a front opening 29 formed in the front wall 27 which has such dimensions as to allow to extract products 9 that have fallen onto the bottom 25, and a rear flap 30 which is articulated to the front flap 26, for example by means of a lever system 32.

In order to access the collection tray 24, the consumer must therefore push against the front flap 26, so as to make it perform an angular stroke L and retract into the compartment 23 until a gap sufficient to extract the product 9 that has fallen onto the bottom 25 is obtained.

In order to prevent access from the outside to the products 9 arranged on the respective containment trays 10, the rear flap 30 pivoted to the front partition 4 by means of a horizontal pivot 34 is guided, during use, by the front flap 26 by means of the lever system 32 so that it performs an angular stroke M in the opposite direction with respect to the angular stroke L imparted to the front flap 26, so as to move between a vertical inactive position and a horizontal position (see FIG. 1) in which it closes in a transverse direction the compartment 23 just above the opening 29.

Once the product 9 has been extracted from the collection tray 24, the front flap 26 automatically resumes its inactive position, i.e., the vertical one, so as to completely close the opening 29, while the rear flap 30 is actuated so as to rise and abut against the front partition 4.

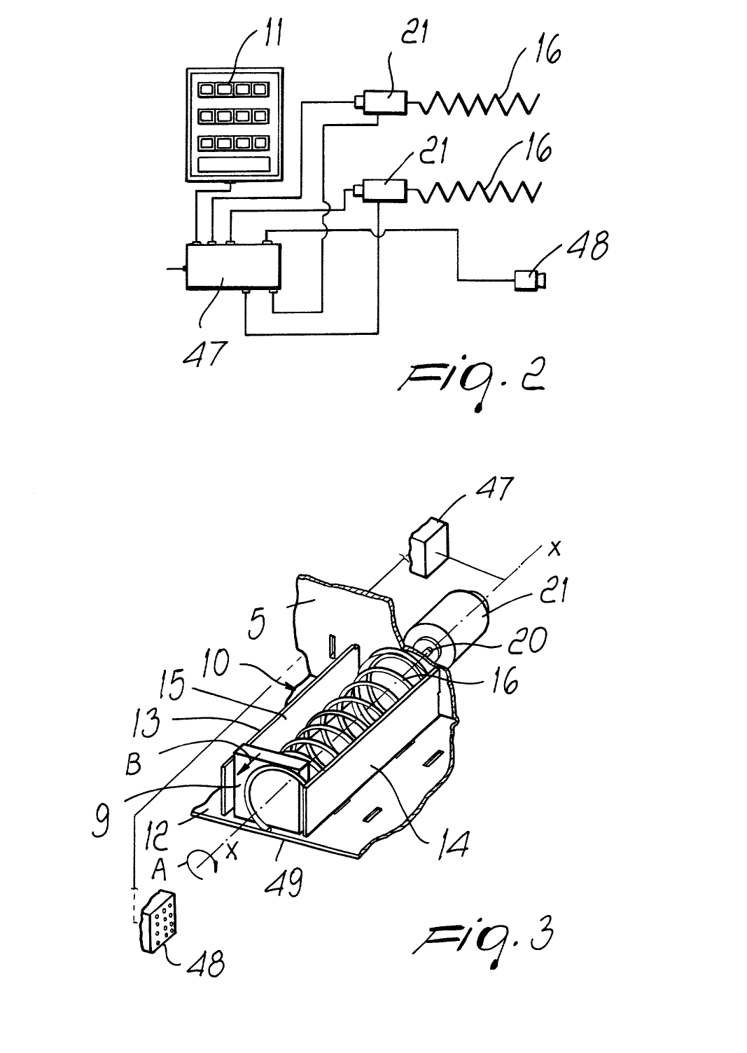

In order to ensure that each product 9 selected by the consumer is actually dropped from the respective dispensing tray 10 into the collection tray 24, the vending machine 1 is advantageously provided with an expulsion device 46, shown schematically in FIG. 2.

The expulsion device 46 preferably comprises a monitoring and control unit 47, which is electrically connected to the motors 21 of the dispenser elements 16, and at least one sensor 48, for example of the photocell type, which is mounted on the containment frame 2 and is suitable to emit a plurality of beams in order to detect that a selected product 9 has fallen through the compartment 23.

Advantageously, the sensor 48 can be installed proximate to the bottom 25 of the collection tray 24 and connected to the monitoring and control unit 47, so as to send to it a signal of the on/off type regarding the successful fall of the product into the collection tray 24.

If the product 9 has failed to fall, the sensor 48 is adapted to indicate this malfunction to the monitoring and control unit 47. The monitoring and control unit 47 is therefore programmed to identify the motor 21 that drives the dispenser element 16 that is responsible for the failure to fall of the preselected product 9 and to drive the motor so as to impart to the respective dispenser element 16 an additional partial rotation, to ensure the fall of the product 9 into the underlying collection tray 24.

Advantageously, the monitoring and control unit 47 is preset so as to make said dispenser element 16 perform an additional partial rotation through a quarter turn, which is sufficient to disengage any product stuck between the respective dispenser element 16 and dispensing tray 10.

Furthermore, the monitoring and control unit 47 is adapted to memorize the occurrence of the rotation of each dispenser element 16 through said additional quarter turn, so as to impart thereto, when a subsequent preselection of the corresponding product 9 occurs, a rotation which is the full-turn complement of said additional quarter turn. In this manner, any dispenser element 16 that has already been subjected to an additional quarter turn during a previous preselection is actuated so as to perform, during a subsequent preselection, a three-quarter turn, so as to reestablish the correct arrangement of the products 9 distributed therein with respect to the corresponding dispensing tray 10.

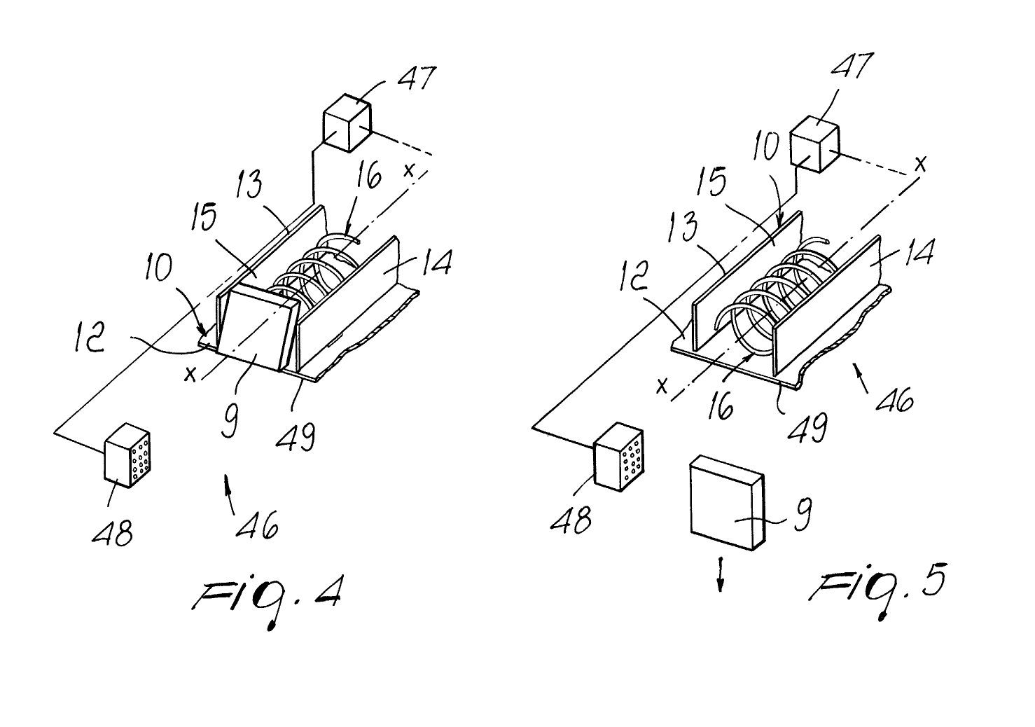

FIGS. 3, 4 and 5 illustrate three main steps of the operation of the expulsion device 46.

After the consumer has preselected an intended product 9, for example by means of a keyboard 11, the monitoring and control unit 47 orders the motor 21 of the corresponding dispenser element 16 to impart to the latter a predefined rotation, which is generally equal to a full turn about its own axis X-X. As shown in FIG. 3, the rotation of the dispenser element 16 (designated by the letter A) about the axis X-X forces the product 9 arranged between two consecutive turns 17 to advance in the direction designated by the letter B toward the front edge 49 of the respective dispensing tray 10.

If the product 9, at the end of the rotation initially imparted to the respective dispenser element 16, gets stuck at the front edge 49 of the respective dispensing tray 10, the sensor 48 detects that the product 9 has failed to fall through the compartment 23 and reports this to the monitoring and control unit 47, which drives the respective motor 21 so as to impart an additional quarter turn to the dispenser element 16. The product 9 is therefore pushed further forward by the first turn 17 of the dispenser element 16, until it disengages from the obstacle and falls by gravity toward the underlying collection tray 24, interrupting the beams emitted by the sensor 48, which sends to the monitoring and control unit 47 a signal indicating successful expulsion of the product 9.

Advantageously, the expulsion device 46 is provided with a timer (not shown in the figures) which is suitable to limit the sensing activity of the sensors 48 within a preset time interval.

The timer can be constituted by a time-controlled counter which can be activated by the monitoring and control unit 47 when the consumer preselects a product 9 and can be deactivated by said unit upon receiving the signal indicating successful expulsion of the product 9, which is sent to it by the respective sensor 48.

The expulsion device as described above is susceptible of numerous modifications and variations within the protective scope defined by the content of the appended claims.

Thus, for example, a vending machine 1 can be provided with a plurality of sensors 48 which are connected to the monitoring and control unit 47, each sensor being arranged in front of a respective supporting shelf 6 and in front of the respective dispenser element 16 and being suitable to detect the successful fall of a product 9 from the corresponding dispensing tray 10. This configuration has the advantage of ensuring a more immediate response if the product 9 is not dispensed.

In another embodiment of the above described expulsion device, the vending machine 1 is provided with a button (not shown) which can be accessed from outside and by which the consumer can drive the motor 21 of the dispenser element 16 that has not expelled the selected product 9 so that said motor turns the corresponding dispenser element 16 through an additional quarter turn which is sufficient to ensure the fall of the product 9 into the collection tray 24.

The above described configuration for the expulsion device is simple and inexpensive to manufacture, since it requires neither the sensors 48 for detecting the fall of the product 9, as this task is entrusted to the consumer, nor a system suitable to connect the sensors 48 to the monitoring and control unit 47, since it is again the consumer who sends to the monitoring and control unit 47, by pressing said button, the signal indicating failure to expel the product 9 from the respective dispensing tray 10.

In practice, the materials and the dimensions may be any according to requirements.

The disclosures in Italian Utility Model Application No. VR2000U000037 from which this application claims priority are incorporated herein by reference.

What is claimed is:

1. A device for expelling a product from a vending machine, said vending machine comprising a containment frame, a plurality of supporting shelves provided within said containment frame, at least one dispensing tray which is slidingly mounted on a respective supporting shelf so as to move between a position for loading products to be dispensed, in which it is at least partially extracted from said containment frame, and a position for unloading said products to be dispensed, in which it is fully contained within said containment frame, at least one collection tray for the products unloaded from the respective, or each, said dispensing tray which can be accessed from outside, and at least one helical dispenser element which lies above a respective dispensing tray and is suitable to accommodate, between at least two consecutive turns, a product to be dispensed, so as to make it advance along the respective dispensing tray by rotating about its own longitudinal axis, until it falls by gravity into said collection tray, further comprising control means which are suitable to drive the motor of the respective helical dispenser element so as to make it perform an additional partial rotation if said product fails to fall from the respective dispensing tray, so as to ensure the fall of said product into said collection tray.

2. The device according to claim 1, wherein said control means comprise sensor means which are arranged downstream of the or each helical dispenser element and are suitable to check whether the product chosen by the consumer has fallen from the corresponding dispensing tray.

3. The device according to claim 2, further comprising a monitoring and control unit which is suitable to receive, from said sensor means, an on/off signal related to the expulsion of said product from the corresponding dispensing tray and, in case of failed expulsion, to drive the motor of the respective helical dispenser element so as to make it perform an additional quarter turn, said monitoring and control unit being suitable to memorize the occurrence of the rotation of the or each helical dispenser element through said additional quarter turn, so as to impart thereto, during a subsequent preselection of the corresponding product, a rotation which is the full-turn complement of said additional quarter turn.

4. The device according to claim 2, wherein said sensor means comprises at least one sensor for each spring-loaded dispenser element provided along a falling path of a product, said falling path lying between the respective dispensing tray and the, or the respective, collection tray.

5. The device according to claim 2, wherein said sensor means comprises at least one sensor which is arranged at said collection tray and is suitable to detect the presence therein of a product at least within a time period which is predefined starting from when said product is preselected.

6. The device according to claim 5, comprising a timer device which is suitable to activate the respective sensor for a predefined time period starting from when the consumer preselects said product.

7. The device according to claim 6, wherein said timer device comprises a time-controlled counter which can be activated by said monitoring and control unit when a product is preselected and can be deactivated by said unit when it receives the signal indicating successful expulsion of said product, which is sent to it by the respective sensor.
